(19) United States
(12) Patent Application Publication
(10) Pub. No.: US 2003/0019695 A1
(43) Pub. Date: Jan. 30, 2003

(54) Automatic adjustment device for a disc of a bicycle brake

(75) Inventors: Chin-Lang Lai, Changhua Hsien (TW); Chin-Shen Liu, Taichung (TW); Jui-Yu Ho, Taichung Hsien (TW); Chih-Tsung Hou, Taichung Hsien (TW)

Correspondence Address: Kolisch, Hartwell, Dickinson, McCormack & Heuser, Suite 200, 520 S.W. Yamhill Street, Portland, OR, 97204-1378, US

(73) Assignee: Falcon Cycle-Parts Co. Ltd.

(21) Appl. No.: 09/918,772

(22) Filed: Jul. 30, 2001

(51) Int. Cl. F16D 55/02

(52) U.S. Cl. 188/71.8; 188/71.1

(57) ABSTRACT

An automatic adjustment device for a disc of a bicycle brake includes a seat adapted to be mounted to a brake device, and a sliding rod adapted to be attached to a fork of the bicycle, and the sliding rod slidably mounted on the seat. The brake device is moved horizontally relative to a brake disc of the bicycle to balance the pressure of the two opposite sides of the brake disc.

### BACKGROUND OF THE INVENTION

1. Field of the Invention

The present invention relates to an automatic adjustment device, and more particularly to an automatic adjustment device for a disc of a bicycle brake.

2. Description of Related Art

With reference to FIGS. 6 and 7, a conventional automatic adjustment device for a disc of a bicycle brake in accordance with the prior art comprises a seat (50) mounted on the bicycle brake. The seat (50) has a top, a bottom, a front, a rear, a first side and a second side. Two ears (51) extend from the front of the seat (50) with one ear (51) at the top and the other at the bottom. A threaded hole (not shown) is formed in each of the ears (51). The automatic adjustment device is mounted a bracket (31) on a fork (31) of a bicycle with bolts (52) that extend through corresponding holes (not shown) in the bracket (31) and screw into the corresponding threaded hole in the ears (51) on the seat (50). Two ears (53) respectively extend the top and bottom of the rear of the seat (50). The automatic adjustment device is adapted to be mounted on a brake device by using a bolt (54) extending through the ear (53) and screwed into the brake device that includes two brake pads mounted to press against the brake disc. By such a manner, the brake device is moved transversely relative to the brake disc to balance the clamping force on opposite sides of the brake disc when the brake is applied.

However, the sliding rod is mounted in the brake device and connected to the automatic adjustment device by bolt so that the movement of the brake device is very short due to the intensity of the bolt. The brake disc and the brake pad are worn during braking so that the gap between the brake pad and the brake disc becomes wider. The automatic adjustment device will be useless when the gap becomes wider and greater than the movement of the brake device.

The present invention has arisen to mitigate and/or obviate the disadvantages of the conventional automatic adjustment device for a disc brake of a bicycle.

### SUMMARY OF THE lVNENTION

The main objective of the present invention is to provide an automatic adjustment device for a disc of a bicycle brake, which can accommodate the normal wear of the brake pads and still remain fully operational.

To achieve the objective, the automatic adjustment device for a disc of a bicycle brake in accordance with the present invention includes a seat and a sliding rod. The seat adapted to be mounted on the bicycle brake, and the sliding rod adapted to be attached to a fork of the bicycle and slidably connected to the seat. The bicycle brake can be moved transversely relative to a brake disc of the bicycle to equalize the pressure applied to the two opposite sides of the brake disc. The seat slides on the sliding rod and the brake device is mounted on the seat so that the movement of the braking device is greatly lengthened.

Further benefits and advantages of the present invention will become apparent after a careful reading of the detailed description with appropriate reference to the accompanying drawings.

### BRIEF DESCRIPTION OF THE DRAWINGS

FIG. 1 is a left side plan view of an automatic adjustment device for a disc of a bicycle brake in accordance with the present invention;

FIG. 2 is a rear plan view of the automatic adjustment device for a disc of a bicycle brake in FIG. 1;

FIG. 3 is an operational left side plan view of the automatic adjustment device for a disc of a bicycle brake in FIG. 1;

FIG. 4 is an operational rear plan view of the automatic adjustment device for a disc of a bicycle brake in FIG. 1;

FIG. 5 is an operational front plan view of the automatic adjustment device for a disc of a bicycle brake in FIG. 1;

FIG. 6 is a left side plan view of a conventional automatic adjustment device for a disc of a bicycle brake in accordance with the prior art; and

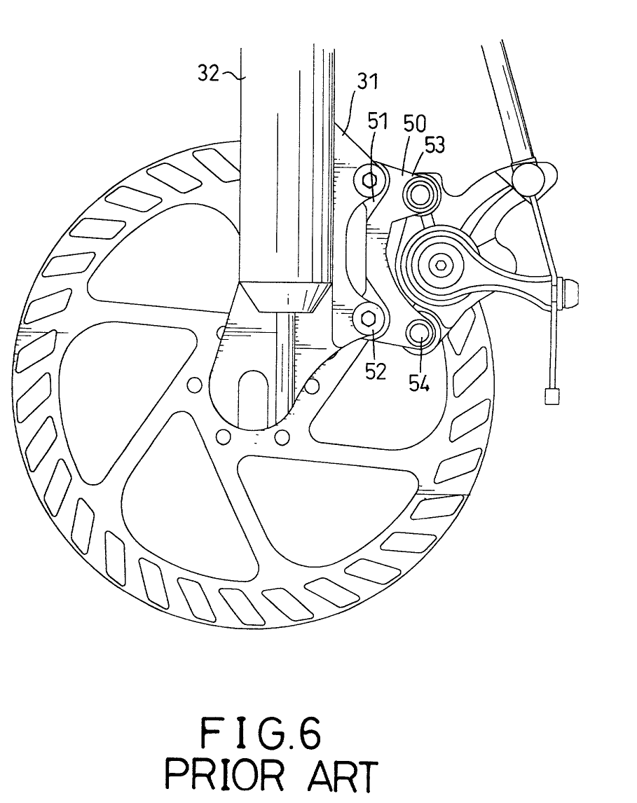

FIG. 7 is a rear plan view of the conventional automatic adjustment device for a disc of a bicycle brake in FIG. 6.

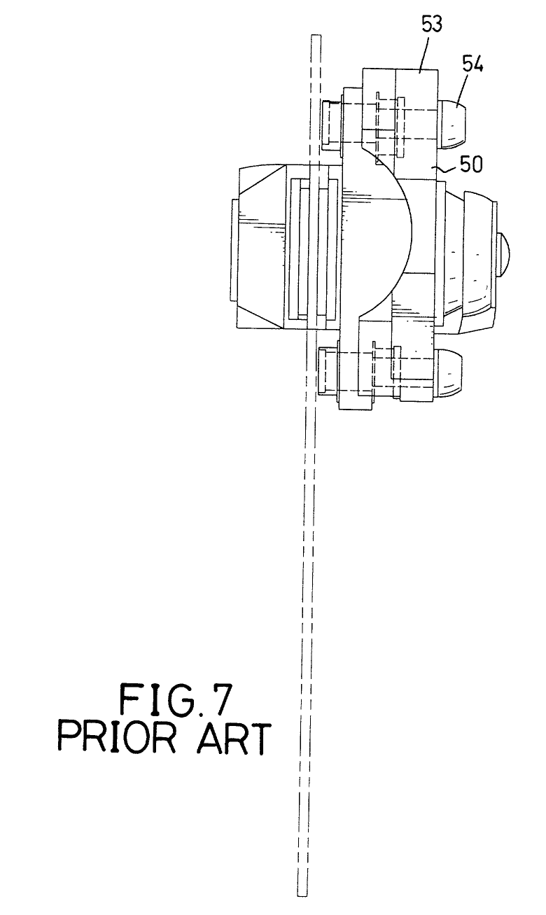

### DETAILED DESCRIPTION OF THE INVENTION

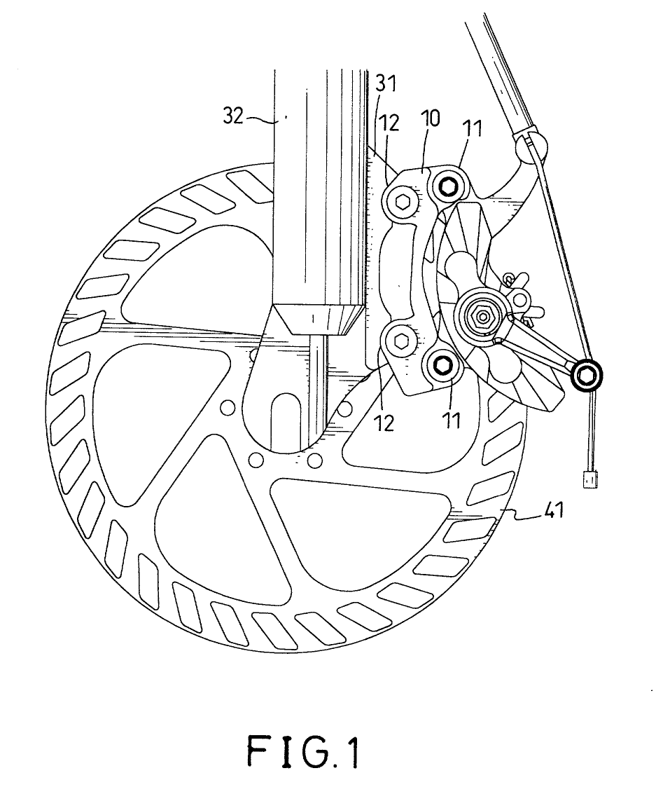

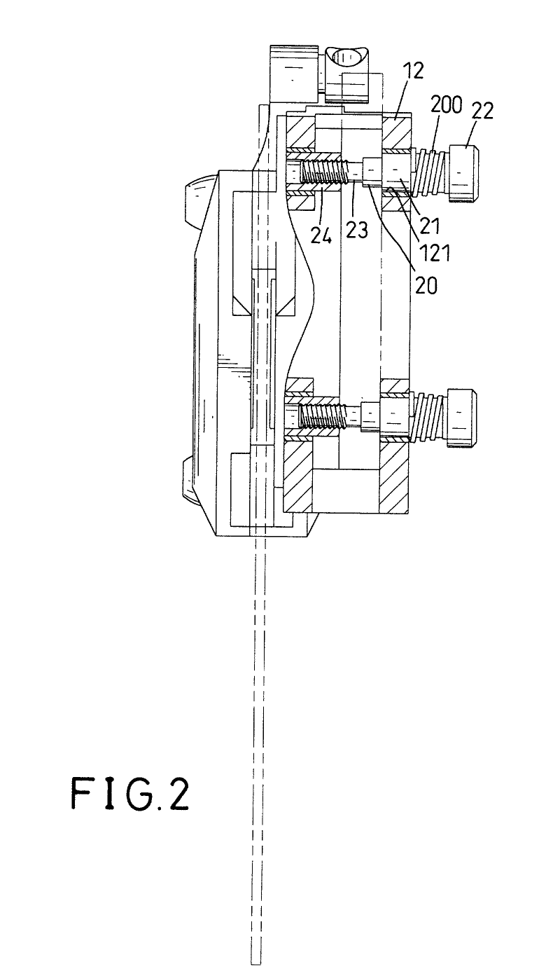

With reference to the drawings and initially to FIGS. 1 and 2, an automatic adjustment device for a disc of a bicycle brake in accordance with the present invention comprises a seat (10) with a first side and a second side and at least two sliding rods (20) parallel to each other. The seat (10) is adapted to be mounted on the bicycle brake. The bicycle brake includes a brake disc (41) mounted on a front or rear wheel (not shown) of the bicycle. The sliding rod (20) is slidably mounted in the seat (10) and adapted to be attached to a bracket (31) on a fork (32) of the bicycle.

The seat (10) has a top, bottom, front and rear edge. Two ears (11) respectively extend from top and bottom of the rear edge of the seat (10), and each ear (11) has a through hole (not shown) and is adapted to be securely connected to the bicycle brake by bolts (not numbered). At least one side of the front face parallel to the brake disc (41) has At least two ears (12) respectively extend from the top and bottom of the front edge of the seat (10), a through hole (121) is defined in each ear (12). The through hole (121) has an axis perpendicular to the brake disc (41). In the preferred embodiment of the present invention, each of two sides of the front edge of the seat (10) has two ears (12), and each ear (12) has a through hole (121) axially aligning with each other.

The sliding rod (20) is slidably mounted in two through holes (121) in one side of the front edge of the seat (10). The sliding rod (20) comprises a shank (21) having a head (22) formed on one end of the shank (21) opposite to the bicycle brake. A spring (200) is mounted around the shank (21) and between the head (22) and the ear (11) to provide a restitution force to the present invention. A stub (23) axially extends from the shank (21) opposite to the head (22) and has a threaded free end. The stub (23) has a diameter smaller than that of the shank (21). A block (24) is mounted on the free end of the stub (23) and slidably received in the other through hole (121) on one side of the front edge of the seat (10). The block (24) has a threaded hole defined to be screwed onto the free end of the stub (23).

To assemble the present invention, the bicycle brake is mounted on the ear (11) extending from the rear edge of the seat (10). The shank (21) of the sliding rod (20) extending through the spring (200) and the ear (12) on the front edge of the seat (10), and the stub (23) extending through the frame of the bicycle. Lately, the block (24) mounted to the free end of the stub (23) to hold the present invention in place on the frame of the bicycle.

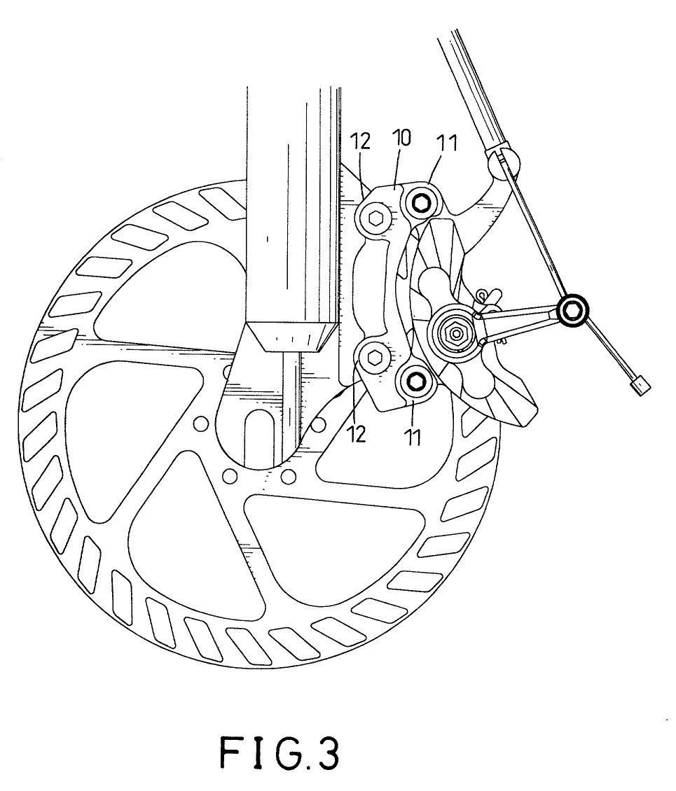

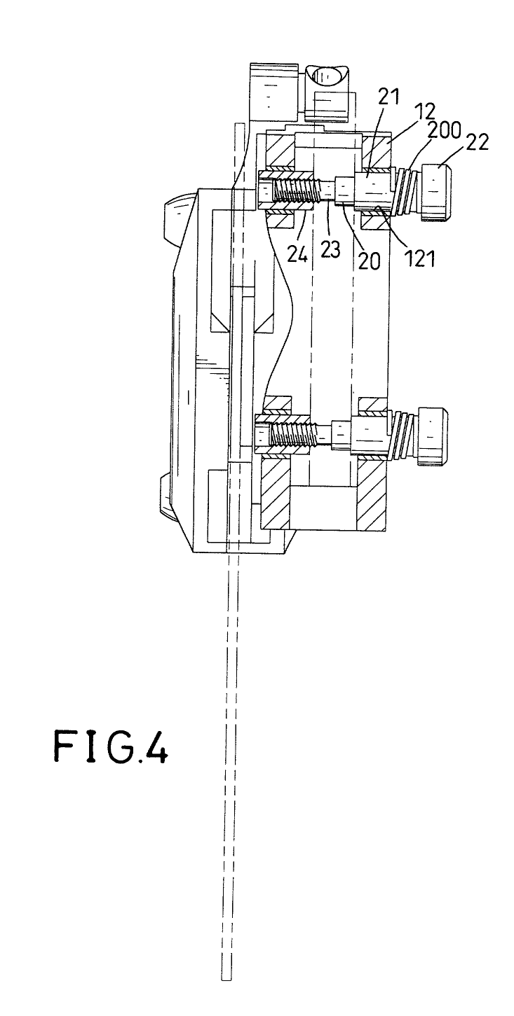

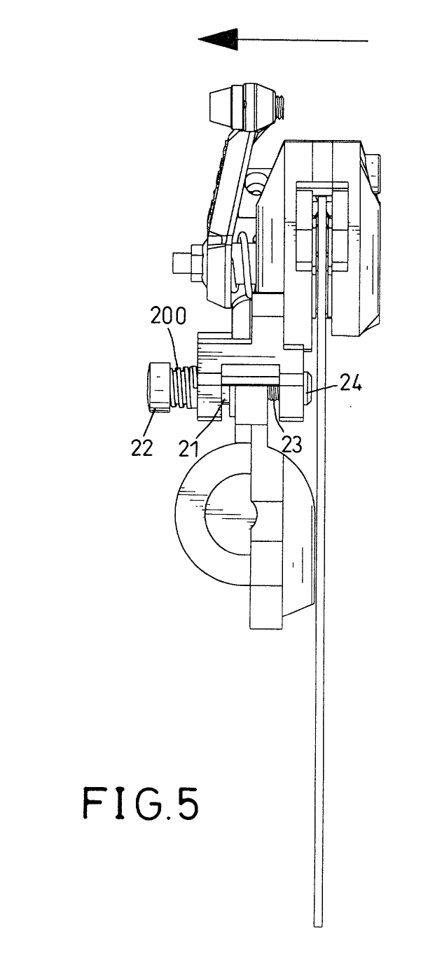

With reference to FIGS. 3, 4 and 5, the first pad mounted near the frame is moved to press against the brake disc when the lever of the brake device is wrenched. The second brake pad is moved to press against the other side of the brake disc when the reactive force between the brake disc and the first brake pad is greater than the resilient force of the spring (200). The bicycle brake can be moved horizontally relative to a brake disc (41) of the bicycle to balance the pressure of the two opposite sides of the brake disc and the movement of the brake device is longer than that of the conventional brake device.

Although the invention has been explained in relation to its preferred embodiment, it is to be understood that many other possible modifications and variations can be made without departing from the spirit and scope of the invention as hereinafter claimed.

What is claimed is:

1. An automatic adjustment device for a disc of a bicycle brake comprising:
a seat having a rear edge adapted to be connected with a bicycle brake that has a brake disc mounted on a wheel of the bicycle, and a front edge having at least one ear extending from each of opposite sides of the front edge, each of the ears having a through hole defined to be adapted to axially correspond to the brake disc of the bicycle brake; and
at least two sliding rod respectively and slidably mounted in the through holes of the ears extending from the front edge of the seat, the sliding rod including:
a shank slidably received in the through hole of the ear;
a head formed on one end of the shank opposite to the brake device;
a spring penetrated by the shank and mounted between the ear and the head of the sliding rod;
a stub axially extending from the shank and adapted to extend through the frame of the bicycle, the stub having a diameter smaller than that of the shank and a free end; and
a block attached to the free end of the stub to hold the seat in place on the frame of the bicycle.

2. The automatic adjustment device for a disc of a bicycle brake as claimed in claim 1, wherein each of the opposite sides of the front edge comprises two ears extending from the front edge of the seat and each of the ears having a through hole defined to align with each other, the two through holes having an axis adapted to be perpendicular to a disc of the brake device.

3. The automatic adjustment device for a disc of a bicycle as claimed in claim 1, wherein the free end of the stub is threaded and the block has a threaded hole defined to be screwed onto the free end of the stub.

4. The automatic adjustment device for a disc of a bicycle brake as claimed in claim 1, wherein the rear edge of the seat comprises two ears extending from the rear edge of the seat, the two ears being adapted for mounting the brake device on the seat.

5. The automatic adjustment device for a disc of a bicycle brake as claimed in claim 2, wherein the rear edge of the seat comprises two ears extending from the rear edge of the seat, the two ears being adapted for mounting the brake device on the seat.
